(19) United States
(12) Patent Application Publication
(10) Pub. No.: US 2026/0128622 A1
(43) Pub. Date: May 7, 2026

(54) SYSTEM AND METHOD FOR AMBIENT POWER (AMP) TRANSMISSION

(71) Applicant: NXP USA, Inc., AUSTIN, TX (US)

(72) Inventors: Liwen Chu, San Ramon, CA (US); Rui Cao, Sunnyvale, CA (US); Xilin Cheng, Menlo Park, CA (US); Somayeh Khosroazad, San Jose, CA (US); Hongyuan Zhang, Fremont, CA (US)

(21) Appl. No.: 19/381,830

(22) Filed: Nov. 6, 2025

Related U.S. Application Data
(60) Provisional application No. 63/716,878, filed on Nov. 6, 2024.
(60) Provisional application No. 63/810,245, filed on May 22, 2025.

(51) Int. Cl. H02J 50/80; H04L 1/00; H04L 5/00

(52) U.S. Cl. CPC H02J 50/80; H04L 1/0061; H04L 5/0053

(57) ABSTRACT

Embodiments of a method and apparatus for wireless communications are disclosed. In an embodiment, a wireless device includes a controller configured to generate an AMbient Power (AMP) transmission element, which contains information that indicates a frame format used in the AMP transmission element and a wireless transceiver configured to wirelessly transmit the AMP transmission element.

### CROSS-REFERENCE TO RELATED APPLICATIONS

This application is entitled to the benefit of U.S. Provisional patent application Ser. No. 63/716,878, filed on Nov. 6, 2024 and U.S. Provisional patent application Ser. No. 63/810,245, filed on May 22, 2025, the contents of each of which are incorporated by reference herein in their entireties.

### SUMMARY

Embodiments of a method and apparatus for wireless communications are disclosed. In an embodiment, a wireless device includes a controller configured to generate an AMbient Power (AMP) transmission element, which contains information that indicates a frame format used in the AMP transmission element (e.g., tag type information to indicate one of different frame formats for different tag types) and a wireless transceiver configured to wirelessly transmit the AMP transmission element. Other embodiments are also disclosed.

In an embodiment, the wireless device includes a wireless access point (AP), and the wireless AP includes an AMP tag reader.

In an embodiment, the wireless device includes a non-access point (AP) station (STA), and the non-AP STA includes an AMP tag.

In an embodiment, the AMP transmission element includes a Physical Layer Protocol Data Unit (PPDU), and the PPDU includes a Physical Layer Service Data Unit (PSDU) that carries a frame in the indicated frame format.

In an embodiment, the PPDU carries a physical (PHY) header, and the PHY header contains the information that indicates a tag type of the frame carried in the PSDU.

In an embodiment, the frame includes a frame header field, an optional frame body, and a frame check sequence (FCS).

In an embodiment, the frame header field contains a frame control field, a receiver address (RA) identification (ID) field and/or a transmitter address (TA) ID field, and an optional extended control field.

In an embodiment, the frame control field contains a frame type field and an uplink (UL) data rate field.

In an embodiment, the UL data rate field is reserved in a frame transmitted by a station (STA).

In an embodiment, the UL data rate field is reserved in a frame transmitted by an access point (AP) that solicits an acknowledgement (Ack).

In an embodiment, the frame of a frame type carries a radio frequency identification (RFID) message.

In an embodiment, frames of different tag types have different frame formats.

In an embodiment, an access point (AP) does not transmit an acknowledgement (Ack) to a station (STA) after receiving a response from the STA.

In an embodiment, an AMbient Power (AMP) reader includes a controller configured to generate an AMP transmission element, which contains information that indicates a frame format used in the AMP transmission element, and a wireless transceiver configured to wirelessly transmit the AMP transmission element to an AMP tag.

In an embodiment, a method for wireless communications includes at a wireless device, generating an AMbient Power (AMP) transmission element, which contains information that indicates a frame format used in the AMP transmission element, and from the wireless device, wirelessly transmitting the AMP transmission element.

In an embodiment, the wireless device includes a wireless access point (AP), and the wireless AP includes an AMP tag reader.

In an embodiment, the wireless device includes a non-access point (AP) station (STA), and the non-AP STA includes an AMP tag.

In an embodiment, the AMP transmission element includes a Physical Layer Protocol Data Unit (PPDU), and the PPDU includes a Physical Layer Service Data Unit (PSDU) that carries a frame in the indicated frame format.

In an embodiment, the PPDU carries a physical (PHY) header, and the PHY header contains the information that indicates a tag type of the frame carried in the PSDU.

In an embodiment, the frame includes a frame header field, an optional frame body, and a frame check sequence (FCS).

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a wireless device in accordance with example embodiments.

FIG. 3 depicts a wireless device with multiple wireless transceivers in accordance with example embodiments.

FIG. 4 depicts an example of a frame format.

FIG. 5 depicts an example of a Wireless Local Area Network (WLAN)(PV0) control frame format.

FIG. 6 depicts an example of a PV0 data frame format.

FIG. 7 depicts an example of a PV0 management frame format.

FIG. 8 depicts an example of an Institute of Electrical and Electronics Engineers (IEEE) 802.11ah (PV1) frame format.

FIG. 9 depicts an example of a Wakeup Radio (WUR) frame format.

FIG. 10 depicts an example of a Media Access Control (MAC) header of the WUR frame format depicted in FIG. 9.

FIG. 11 illustrates an IEEE 802.11 bp compatible Physical Layer Protocol Data Unit (PPDU) format in accordance with example embodiments.

FIG. 12 illustrates an IEEE 802.11 bp compatible PPDU format in accordance with example embodiments.

FIG. 13 illustrates an IEEE 802.11 bp compatible frame format in accordance with example embodiments.

FIG. 14 illustrates an IEEE 802.11 bp compatible frame format in accordance with example embodiments.

FIG. 15 illustrates a broadcast trigger frame format in accordance with example embodiments.

FIG. 16 illustrates a unicast trigger frame format in accordance with example embodiments.

FIG. 17 illustrates a response trigger frame format in accordance with example embodiments.

FIG. 18 illustrates an acknowledgement (Ack) frame format in accordance with example embodiments.

FIG. 19 is a process flow diagram of a method for wireless communications in accordance with example embodiments.

FIG. 20 illustrates an AMbient Power (AMP) transmission element in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. Recently, there is a need to define a WLAN for ambient power communications where a station (STA) harvests power from an AP's transmission (e.g., PPDU transmission) or other source for information exchange between the AP and the STA. AMbient Power (AMP) communications can be used to enable battery-free or limited battery applications that are important to low-power Internet of Things (IoT) applications, which can help users within home, enterprise and public access markets and assist manufacturers and operators to provide common components and services for IEEE 802.11 customers. For example, an ambient device can be powered by energy harvesting, being either battery-less or with limited energy storage capability (e.g., using a capacitor). Ambient devices can be capable of harvesting ambient energy to power their internal electronic modules. Common energy that can be harvested includes, but not limited to, radio waves, solar, thermal, and vibration energy. Such ambient power communications can be used for different use cases, e.g., backscatter use cases related to backscatter tags for Radio Frequency Identification (RFID) applications, active transmission for active tags, wake-up radio (WUR) where an AMbient Power (AMP) radio of a client device is used to receive a trigger signal to activate the client device's IEEE 802.11 radio for the information exchange between an AP and the client device through the IEEE 802.11 radio. For example, a backscatter device can send information by re-modulating and passively reflecting incident signals from ambient signal sources, without requiring power-hungry transceivers to generate a carrier signal. When an ambient signal exists, a backscatter device can pick up the ambient signal, rectify a portion of the ambient signal into direct current (DC) to energize the backscatter device and reflect another portion of the ambient signal with a different amplitude to deliver information.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

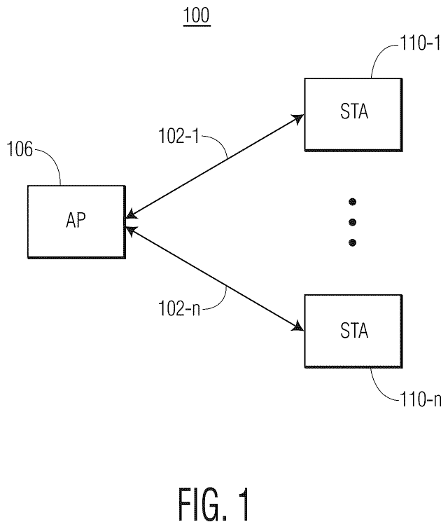

FIG. 1 depicts a wireless (e.g., IEEE 802.11 bp) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as backscatter for RFID where a STA's frame transmission is always solicited by an AP, active transmission where a STA can transmit its information without the soliciting from an AP, and WUR. In some embodiments, the wireless communications system is compatible with an IEEE 802.11 bp protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 bp protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements Media Access Control (MAC) functionalities (e.g., IEEE 802.11 PPDU transmission, IEEE 802.11 bp frame transmission/reception, soliciting an IEEE 11 bp frame from a STA, controlling slot-based medium access, backoff, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a sub-1 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 bp protocol. In some embodiments, the STA 110-1, . . . , or 110-n is implemented in a tag, or other communications device that supports at least one WLAN communications protocol. In some embodiments, the STA 110-1, . . . , or 110-n implements MAC functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented by a control logic, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes IEEE 802.11 bp frames. An IEEE 802.11 bp frame may include a frame header, an optional frame body, and an FCS.

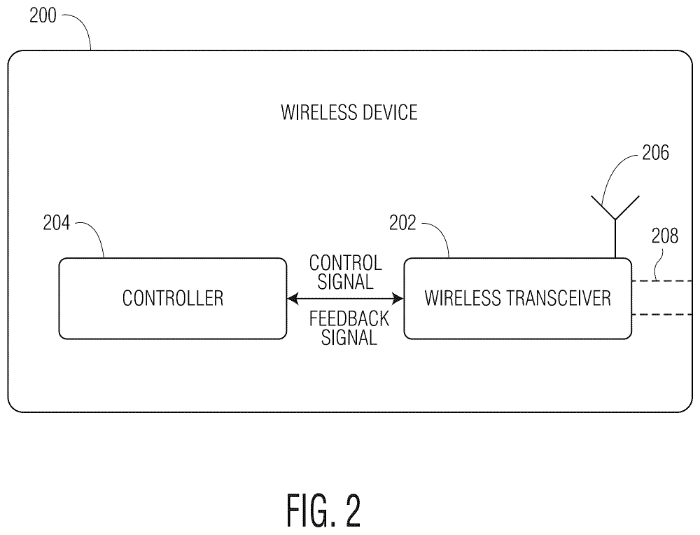

FIG. 2 depicts a wireless device 200 in accordance with example embodiments. The wireless device 200 can be used in the wireless communications system 100 depicted in FIG. 1. For example, the wireless device 200 may be an embodiment of the AP 106 depicted in FIG. 1, and/or the STA 110-1, . . . , 110-n depicted in FIG. 1. In the embodiment depicted in FIG. 2, the wireless device 200 includes a wireless transceiver 202, a controller 204 operably connected to the wireless transceiver, and at least one antenna 206 operably connected to the wireless transceiver. In some embodiments, the wireless device 200 may include at least one optional network port 208 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 bp protocol). In some embodiments, the wireless device 200 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, or a control logic. In some embodiments, the wireless transceiver 202 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some embodiments, the wireless device 200 is an Internet of Things (IoT) tag, such as an AMbient Power (AMP) tag that can harvest energy from its surroundings, such as radio waves or light, to operate without a power source (e.g., a battery). For example, the wireless device 200 is a radio frequency (RF) identification (ID) tag. In some embodiments, the wireless device 200 is a tag reader that includes an AP defined by an IEEE 802.11 bp protocol, such as an AMP reader that can read data from an IoT tag that includes a STA defined by an IEEE 802.11 bp protocol, such as an AMP tag. For example, the wireless device 200 is an RFID tag reader.

In accordance with example embodiments, the controller 204 is configured to generate an AMbient Power (AMP) transmission element, which contains information that indicates a frame format used in the transmission element (e.g., tag type information to indicate one of different frame formats for different tag types), and the wireless transceiver 202 is configured to wirelessly transmit the AMP transmission element, for example, through the at least one antenna 206.

In some embodiments, the wireless device 200 includes a wireless access point (AP), and the wireless AP is part of an AMP tag reader.

In some embodiments, the wireless device 200 includes a non-access point (AP) station (STA), and the non-AP STA is part of an AMP tag.

In some embodiments, the AMP transmission element includes a Physical Layer Protocol Data Unit (PPDU), and the PPDU includes a PHY header and a Physical Layer Service Data Unit (PSDU) that carries a frame in the indicated frame format.

In some embodiments, the PHY header of a PPDU carries an AMP Signal field (SIG), and the AMP SIG or the other part of PHY header contains the information that indicates the tag type of the frame carried in the PSDU where different tag types of backscatter tag, active tag, WUR indicate different frame formats of the frames. In some embodiments, the frames with the same frame type but different tag types can have the different formats. In some embodiments, the frame with the tag type of backscatter tag includes a frame body that carries a radio frequency (RF) identification (ID) message.

In some embodiments, the frame carried in a PSDU carries a frame header with at least one frame control (FC) field, and the FC field contains the information that indicates the frame format of the frame carried in the PSDU. In some embodiments, the frame includes a frame header, which contains the FC field, an optional frame body, and a frame check sequence (FCS).

In some embodiments, the frame format contains a frame header that includes a frame control field and a receiver address and/or transmitter address identification (ID) field.

In some embodiments, the frame control field includes a tag type field, a frame type field, a protection indication field, and an uplink (UL) data rate field. In some embodiments, the protection indication field does not exist in a frame of backscatter tag. In some embodiments, the protection indication field is reserved in a frame of backscatter tag.

In some embodiments, the frame control field includes a frame type field, a protection indication field, a downlink (UL) data rate field, and a session ID field. In some embodiments, the protection indication field does not exist in a frame of backscatter tag. In some embodiments, the protection indication field is reserved in a frame of backscatter tag.

In some embodiments, the AMP transmission element is decoded using the frame format.

In some embodiments, the wireless device 200 is compatible with an Institute of Electrical and Electronics Engineers (IEEE) 802.11 bp protocol.

In some embodiments, an AMbient Power (AMP) reader includes a controller configured to generate an AMP transmission element, which contains information that indicates a frame format used in the transmission element and a wireless transceiver configured to wirelessly transmit the AMP transmission element to an AMP tag.

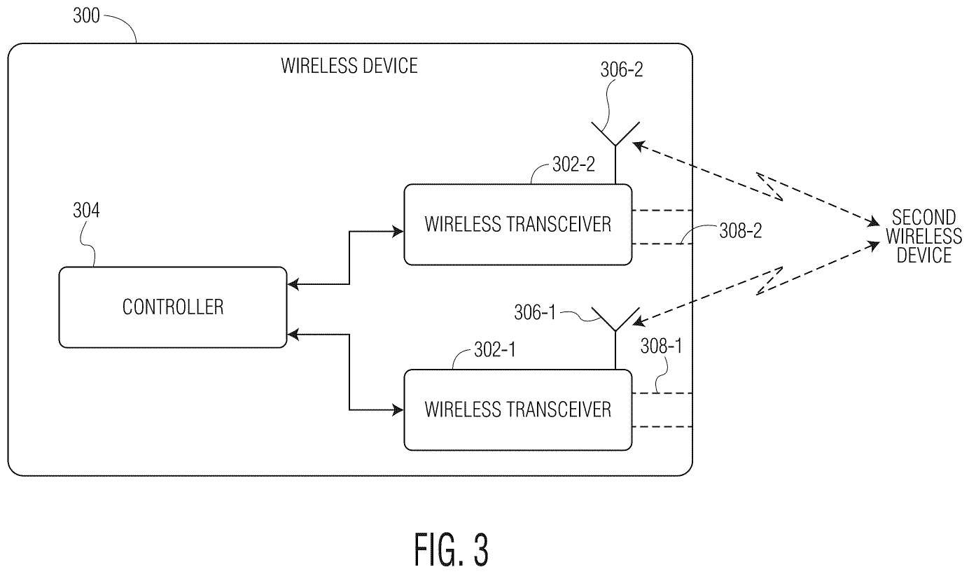

FIG. 3 depicts a wireless device 300 with multiple wireless transceivers 302-1, 302-2 in accordance with example embodiments. The wireless device 300 depicted in FIG. 3 may be an embodiment of the AP 106 depicted in FIG. 1 and/or the STA 110-1, . . . , 110-n depicted in FIG. 1. However, the AP 106 depicted in FIG. 1 and/or the STA 110-1, . . . , 110-n depicted in FIG. 1 is not limited to the embodiment depicted in FIG. 3. The wireless device 300 can be used in the wireless communications system 100 depicted in FIG. 1. In the embodiment depicted in FIG. 3, the wireless device 300 includes the first wireless transceiver 302-1, the second wireless transceiver 302-2, a controller 304 operably connected to the wireless transceiver, a first antenna 306-1 operably connected to the first wireless transceiver 302-1, and a second antenna 306-2 operably connected to the second wireless transceiver 302-2. In some embodiments, the wireless device 300 may include one or more optional network ports 308-1, 308-2 operably connected to the wireless transceivers 302-1, 302-2. In some embodiments, at least one of the wireless transceivers 302-1, 302-2 includes a physical layer (PHY) device. The wireless transceivers 302-1, 302-2 may be any suitable type of wireless transceiver. In some embodiments, one of the wireless transceivers 302-1, 302-2 is an AMbient Power (AMP) radio. For example, one of the wireless transceivers 302-1, 302-2 may be a WLAN transceiver (e.g., a transceiver compatible with an IEEE 802.11 protocol) while another one of the wireless transceivers 302-1, 302-2 may be a short-range transceiver (e.g., a transceiver compatible with an RFID or AMP communications protocol). The controller may be configured to control the wireless transceivers 302-1, 302-2 (e.g., by generating one or more control signals) to process packets received through the antennas 306-1, 306-2 and/or the network ports 308-1, 308-2 and/or to generate outgoing packets to be transmitted through the antennas 306-1, 306-2 and/or the network ports 308-1, 308-2. In some embodiments, the wireless transceivers 302-1, 302-2 transmits one or more feedback signals to the controller 304. In some embodiments, the controller is implemented within a processor, such as a microcontroller, a host processor, a host, a DSP, or a CPU. In some embodiments, at least one of the wireless transceivers 302-1, 302-2 is implemented in hardware (e.g., circuits), software, firmware, or a combination thereof. The antenna may be any suitable type of antenna. For example, at least one of the antennas 306-1, 306-2 may be an induction type antenna such as a loop antenna or any other suitable type of induction type antenna. However, the antennas 306-1, 306-2 are not limited to induction type antennas. The network ports 308-1, 308-2 may be any suitable type of ports. For example, at least one of the network ports 308-1, 308-2 is an LAN port (e.g., an Ethernet port). Although the depicted wireless device 300 is shown in FIG. 3 with certain components and described with certain functionality herein, other embodiments of the wireless device 300 may include fewer or more components to implement the same, less, or more functionality. For example, although the wireless device 300 is shown in FIG. 3 as being connected in a certain topology, the network topology of the wireless device 300 is not limited to the topology shown in FIG. 3. In another example, in some embodiments, the wireless device includes multiple controllers with multiple wireless transceivers, a single antenna, more than two wireless transceivers, more than one antennas, and/or more than two network ports. In some embodiments, the wireless device 300 is a wireless access point (AP) or a non-AP wireless station (STA) device.

In accordance with example embodiments, the controller 304 is configured to generate an AMbient Power (AMP) transmission element, which contains information that indicates a frame format used in the AMP transmission element (e.g., tag type information to indicate one of different frame formats for different tag types), and the wireless transceiver 302-1 or 302-2 is configured to wirelessly transmit the AMP transmission element, for example, through the antenna 306-1 or 306-2. In some embodiments, the wireless device 300 includes a wireless access point (AP) that is an AMP tag reader. In some embodiments, the wireless device includes a non-access point (AP) station (STA) that is an AMP tag. In some embodiments, the AMP transmission element includes a Physical Layer Protocol Data Unit (PPDU), and the PPDU includes a Physical Layer Service Data Unit (PSDU) that carries a frame in the indicated frame format. In some embodiments, the PPDU carries a physical (PHY) header, and the PHY header contains the information that indicates a tag type of the frame carried in the PSDU. In some embodiments, the frame includes a frame header field, an optional frame body, and a frame check sequence (FCS). In some embodiments, the frame header field contains a frame control field, a receiver address (RA) identification (ID) field and/or a transmitter address (TA) ID field, and an optional extended control field. In some embodiments, the frame control field contains a frame type field and an uplink (UL) data rate field. In some embodiments, the UL data rate field is reserved in a frame transmitted by a station (STA). In some embodiments, the UL data rate field is reserved in a frame transmitted by an access point (AP) that solicits an acknowledgement (Ack). In some embodiments, the frame of a frame type carries a radio frequency identification (RFID) message. In some embodiments, frames of different tag types have different frame formats. In some embodiments, an access point (AP) does not transmit an acknowledgement (Ack) to a station (STA) after receiving a response from the STA.

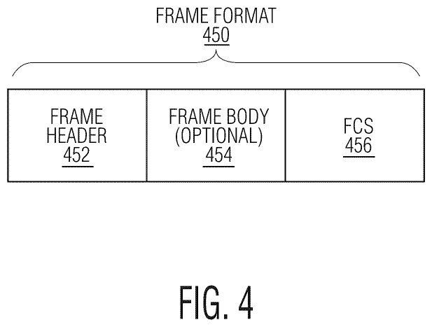

FIG. 4 depicts an example of a frame format 450. The frame format 450 illustrated in FIG. 4 can be used for communications by the STAs/AP in the wireless communications system 100 depicted in FIG. 1, by the wireless device 200 depicted in FIG. 2, and/or the wireless device 300 depicted in FIG. 3. As depicted in FIG. 4, the frame format 450 include a frame header (e.g., a Media Access Control (MAC) header) 452, an optional frame body 454, and a frame check sequence (FCS) 456.

IEEE 802.11 standards define the different frame formats of wakeup radio (WUR) frames, PV1 frames, PV0 frames that include PV0 Control frames, PV0 Management frame, and PV0 Data frame. PV0, PV1 and WUR are three frame type groups of frame formats with the indication of frame type group in PHY header and MAC header. In each PV0 frame, the different values in the frame type field of MAC header field indicate whether the PV0 frame is PV0 control frame, PV0 data frame or PV0 management frame.

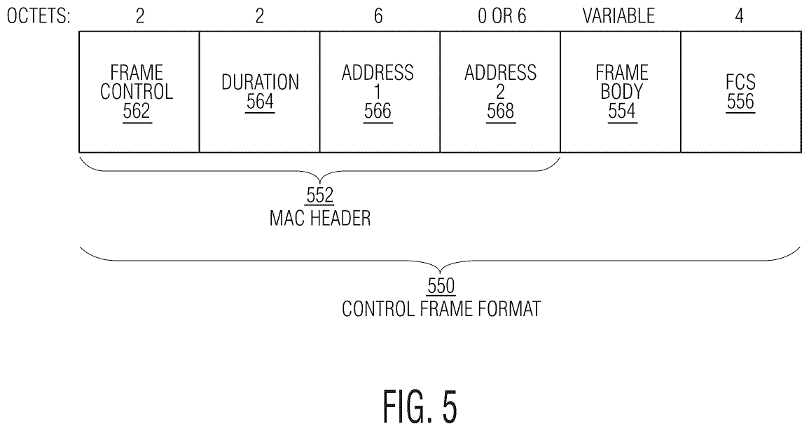

FIG. 5 depicts an example of a PV0 control frame format 550. The PV0 control frame format 550 depicted in FIG. 5 can be used for communications by the wireless communications system 100 depicted in FIG. 1, the wireless device 200 depicted in FIG. 2, and/or the wireless device 300 depicted in FIG. 3. As depicted in FIG. 5, the PV0 control frame format 550 include a MAC header 552, a frame body 554 (e.g., variable length), and an FCS 556 (e.g., four octets). As depicted in FIG. 5, the MAC header 552 includes a frame control field 562 (e.g., two octets), a duration field 564 (e.g., two octets), a first address field 566 (e.g., six octets), and a second address field 568 (e.g., zero or six octets). In the frame control field 562, frame type and frame subtype exist where the special value in the frame type field indicates PV0 control frame, and the various values in the frame subtype field of the PV0 control frames indicates the different types (e.g. Ack, Block Ack, request to send (RTS), clear to send (CTS), Trigger) of the control frames with the different frame formats.

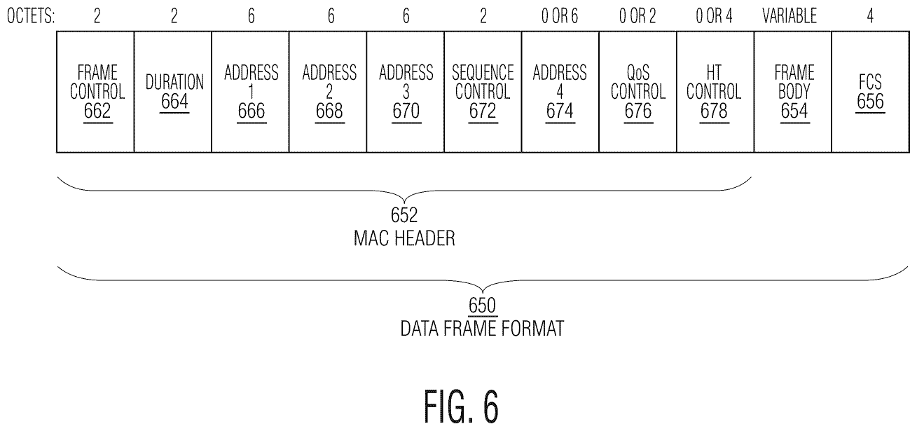

FIG. 6 depicts an example of a PV0 data frame format 650. The PV0 data frame format 650 depicted in FIG. 6 can be used for communications by the wireless communications system 100 depicted in FIG. 1, the wireless device 200 depicted in FIG. 2, and/or the wireless device 300 depicted in FIG. 3. As depicted in FIG. 6, the PV0 data frame format 650 include a MAC header 652, a frame body 654 (e.g., variable length), and an FCS 656 (e.g., four octets). As depicted in FIG. 6, the MAC header 652 includes a frame control field 662 (e.g., two octets), a duration field 664 (e.g., two octets), a first address field 666 (e.g., six octets), a second address field 668 (e.g., six octets), a third address field 670 (e.g., six octets), a sequence control field 672 (e.g., two octets), a fourth address field 674 (e.g., zero or six octets), a QoS control field 676 (e.g., zero or two octets), and a High Throughput (HT) control field 678 (e.g., zero or four octets). In the frame control field 662, frame type and frame subtype exist where the special value in the frame type field indicates PV0 data frame, and the various values in frame subtype field indicates the different types of the data frames with the different frame formats. The frame type and frame subtype in the frame control field 662 and the frame type and frame subtype in the sequence control field 672 are in the same location of the frame control field, respectively.

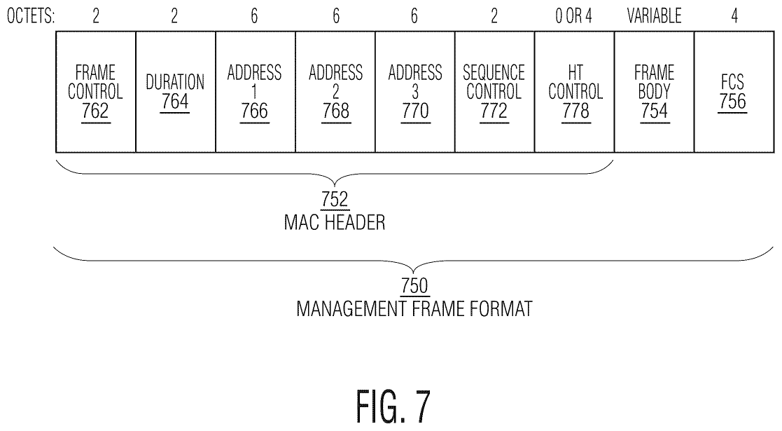

FIG. 7 depicts an example of a PV0 management frame format 750. The PV0 management frame format 750 depicted in FIG. 7 can be used for communications by the wireless communications system 100 depicted in FIG. 1, the wireless device 200 depicted in FIG. 2, and/or the wireless device 300 depicted in FIG. 3. As depicted in FIG. 7, the PV0 management frame format 750 include a MAC header 752, a frame body 754 (e.g., variable length), and an FCS 756 (e.g., four octets). As depicted in FIG. 7, the MAC header 752 includes a frame control field 762 (e.g., two octets), a duration field 764 (e.g., two octets), a first address field 766 (e.g., six octets), a second address field 768 (e.g., six octets), a third address field 770 (e.g., six octets), a sequence control field 772 (e.g., two octets), and a HT control field 778 (e.g., zero or four octets). In the frame control field 762, frame type and frame subtype exist where the special value in the frame type field indicates PV0 management frame, and the various values in the frame subtype field indicates the different types of the management frames with the different frame formats. The frame type and frame subtype in the frame control field 762 and frame type and frame subtype in the sequence control field 772 are in the same location of the frame control field respectively.

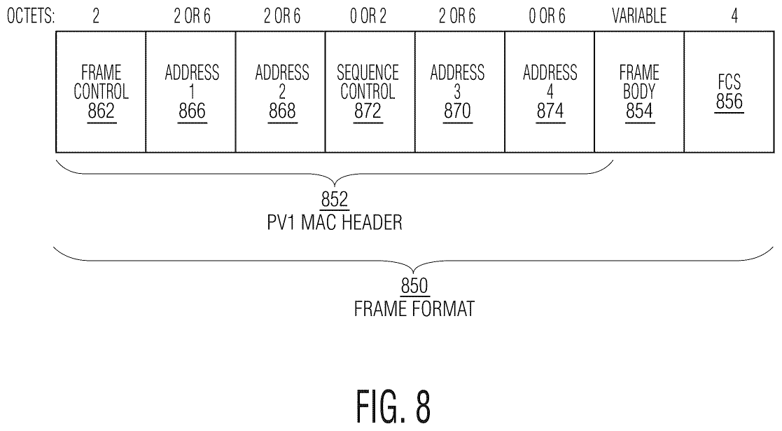

FIG. 8 depicts an example of a PV1 frame format 850. The PV1 frame format 850 depicted in FIG. 8 can be used for communications by the wireless communications system 100 depicted in FIG. 1, the wireless device 200 depicted in FIG. 2, and/or the wireless device 300 depicted in FIG. 3. As depicted in FIG. 8, the PV1 frame format 850 include a MAC header 852, a frame body 854 (e.g., variable length), and an FCS 856 (e.g., four octets). As depicted in FIG. 8, the MAC header 852 includes a frame control field 862 (e.g., two octets), a first address field 866 (e.g., two or six octets), a second address field 868 (e.g., two or six octets), a sequence control field 872 (e.g., zero or two octets), a third address field 870 (e.g., zero or six octets), and a fourth address field 874 (e.g., zero or six octets).

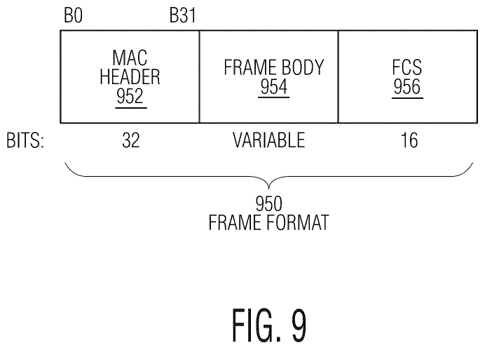

FIG. 9 depicts an example of a WUR frame format 950. The WUR frame format 950 depicted in FIG. 9 can be used for communications by the STAs and the AP in the wireless communications system 100 depicted in FIG. 1, the wireless device 200 depicted in FIG. 2, and/or the wireless device 300 depicted in FIG. 3. As depicted in FIG. 9, the WUR frame format 950 include a MAC header 952 (e.g., 32 bits), a frame body 954 (e.g., variable length), and an FCS 956 (e.g., 16 bits).

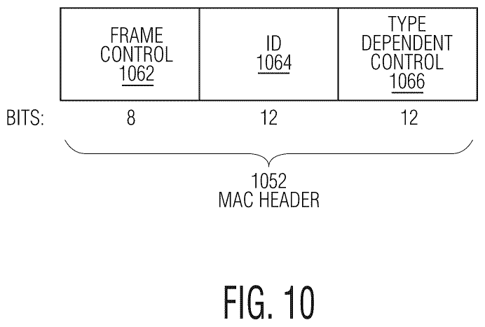

FIG. 10 depicts an example of the MAC header 952 of the WUR frame format 950 depicted in FIG. 9. As depicted in FIG. 10, a MAC header 1052 includes a frame control field 1062 (e.g., 8 bits), an ID field 1064 (e.g., 12 bits), and a Type Dependent Control field 1066 (e.g., 12 bits). In the frame control field 1062, a type field exist where the different values of the type field indicate the different WUR frames (e.g., WUR beacon, WUR wakeup, WUR discovery) with the different frame formats.

In some embodiments, an IEEE 802.11 bp frame has different formats based on whether the IEEE 802.11 bp frame is for RFID, wake up radio (WUR), or active transmission.

In some embodiments, with an IEEE 802.11 bp PHY header in an IEEE 802.11 bp PPDU, the IEEE 802.11 bp SIG in the PHY header or the other field in the PHY header indicates the tag types of the frame (e.g., a PSDU) carried in the PPDU. In the PPDU that indicates the backscatter tag type RFID, the carried frame carries the frame type field that further indicates the frame format where one type of RFID frame carries the RFID message. The different frame types of the RFID tag type are defined with the different frame formats in the backscatter tag type.

In some embodiments, the frame in an IEEE 802.11 bp PPDU (e.g., an IEEE 802.11 bp frame) at least organized with a Frame Header and an FCS. In the PPDU for RFID with the tag type indicating backscatter tag, the frame carries the Frame Header, optional RFID message, and the FCS.

In some embodiments, for each tag type, the frame type field of a MAC Header includes information about various frame format used for the different purposes of the tag type:
the acknowledgement of a soliciting frame;
the broadcast trigger frame that soliciting the random access;
the data frame that carries the up layer message.

In some embodiments, the FCS at the end of a frame verifies whether the MAC header and the frame body of a received frame has error(s) or not (e.g., using a cyclic redundancy check (CRC) to detect error(s) in the received frame).

Some use cases for IEEE 802.11 bp protocols are described as follows.

In some use cases per radio frequency identification (RFID) (backscatter), an IEEE 802.11 bp PHY header indicates the RFID tag type and the different frame formats with the different frame types under the RFID tag (backscatter tag) type are defined. Among the frames under the RFID tag type, an RFID message is carried in one type of an IEEE 802.11 bp frame body after the frame header where the RFID defines the format of the RFID message. The interpretation of the RFID message can be up to an RFID protocol. A STA (e.g., AMbient Power (AMP) tag, such as an IEEE 802.11 bp compatible tag)) can be read by an AP (e.g., an AMP reader). In some cases, there is no power save mode for an AMP tag. In some cases, there is no state/management information maintained in an AP (e.g., an AMP reader) of a STA (e.g., an AMP tag) except the RFID message of the read AMP tag.

In some use cases per wakeup radio (WUR), the wakeup of a STA in a power save mode needs to maintain the STA's state in an associated AP. The 802.11 bp PHY header indicates the WUR tag type. In the PPDU that indicates the WUR tag type, the carried one type of frame carries the wakeup information and the identifier of the STA to indicate that the STA needs to wake up.

Some implementations of tag type indication, for example, by the STA/AP in the wireless communications system 100 depicted in FIG. 1, the wireless device 200 depicted in FIG. 2, and/or the wireless device 300 depicted in FIG. 3 are described.

In some embodiments, an IEEE 802.11 bp PPDU format is one of the following:

```
  802.11 non-HT (High Throughput) Long Training Field (LTF) + 802.11
Short Training Field (STF) + 802.11 SIGNAL field (SIG) + AMP
Synchronization (Sync) + PSDU; and
  802.11 non-HT LTF + 802.11 STF + 802.11 SIG + AMP Sync + AMP
SIG + PSDU.
```

In some embodiments, the PSDU carries or contains the frame.

In some embodiments, for tag type identification, in Option 1, AMP SIG carries the tag type indication.

In some embodiments, for tag type identification, in Option 2, the PHY header other than AMP SIG, e.g., the characteristic (different coding/modulation method) of SYNC, carries the tag type indication,

In some embodiments, for tag type identification, in Option 3, FC field in a MAC Header carries the tag type indication.

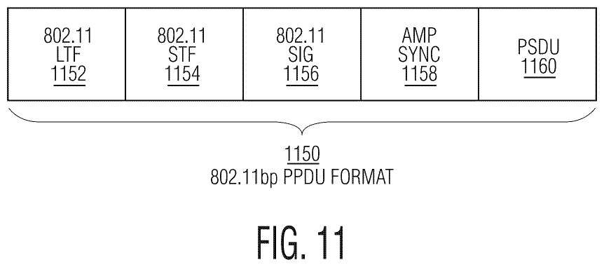

FIG. 11 illustrates an IEEE 802.11 bp compatible PPDU format 1150 in accordance with example embodiments. The IEEE 802.11 bp compatible PPDU format 1150 illustrated in FIG. 11 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 11, the IEEE 802.11 bp compatible PPDU format 1150 include an IEEE 802.11 LTF 1152, an IEEE 802.11 STF 1154, an IEEE 802.11 SIG 1156, an AMP Synchronization (Sync) 1158, and a PSDU 1160.

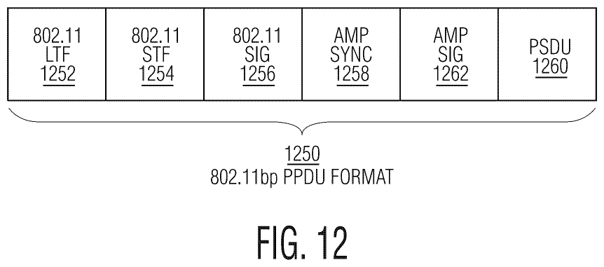

FIG. 12 illustrates an IEEE 802.11 bp compatible PPDU format 1250 in accordance with example embodiments. The IEEE 802.11 bp compatible PPDU format 1250 illustrated in FIG. 12 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 12, the IEEE 802.11 bp compatible PPDU format 1250 include an IEEE 802.11 LTF 1252, an IEEE 802.11 STF 1254, an IEEE 802.11 SIG 1256, an AMP Synchronization (Sync) 1258, a PSDU 1260, and an AMP SIG 1262.

In some embodiments, for tag type of backscatter tag, Frame format 1 is implemented as frame header+optional frame body+FCS field where the frame header includes a frame type field with the different values indicating the different frames with the different formats, e.g., with or without frame body and/or the different frame header format, for RFID use case. Among the different types of frames for RFID use case, the frame of one frame type includes the frame body that carries the RFID message defined by RFID.

In some embodiments, for tag type of WUR, Frame format 2 is implemented as the same as a WUR frame format in an IEEE 802.11 baseline specification, e.g., frame header+optional frame body+FCS field where at least the length of a receiver ID, a transmitter ID, and the frame body are different from the frame of backscatter tag.

Frame format 1 and frame format 2 have the different frame header format, frame body length/content etc.

Some implementations of frames, for example, by the wireless communications system 100 depicted in FIG. 1, the wireless device 200 depicted in FIG. 2, and/or the wireless device 300 depicted in FIG. 3 are described.

In some embodiments, in tag type for backscatter tag (RFID use case) and the other tag type, one type of frame being a trigger frame with a broadcast receiver address (RA) identification (ID) initiates random access in its slot(s).

In some embodiments, in tag type for backscatter tag (RFID use case), one type of frame being a trigger frame with a unicast RA ID solicits an uplink (UL) frame from an indicated tag (STA). In some embodiments, the unicast trigger frame is not needed. In some embodiments, the unicast trigger frame is used to carry the unicast soliciting information (RFID message) where the other unicast downlink (DL) frame is not needed.

In some embodiments, in tag type for backscatter tag (RFID use case), one type of a unicast frame to carry the DL unicast soliciting information, e.g., being named as a data frame or a command frame, includes the frame body that carries at least one RFID command from an upper layer. In some embodiments, the unicast trigger frame is not needed where the data frame or the command frame is also used as the unicast trigger frame.

In some embodiments, in tag type for backscatter tag (RFID use case), one type of the frame being a unicast frame to carry the UL response from the tag, e.g., being named as data frame or command frame, carries one of the following based on the Command in the soliciting unicast Trigger frame:
Electronic product code (EPC);
an authentication response;
the information being read from the tag.

In some embodiments, a data frame for DL soliciting and a data frame for UL response have the same frame type for backscatter tag.

In some embodiments, in tag type for backscatter tag (RFID use case), one type of the frame being a response frame from the tag, e.g., being named as an Ack frame without the frame body, is used to acknowledge the information being written to the tag.

In some embodiments, when all IEEE 802.11 bp frame exchanges are initiated by an AP (e.g., an AMP reader), the Ack frame for each UL frame solicited by the AP's frame, e.g., the Trigger frame, is not needed for the UL information transmission (information read, authentication, EPC acquiring). This is applied at least to the backscatter tag (RFID use case). In some embodiments, if/when the UL frame transmission fails, the AP (e.g., the AMP reader) MAC retransmits its frame, e.g., the Trigger frame. In some embodiments, the following new AP's frame implies the correct reception of the UL frame.

In some embodiments, when the AP (e.g., the AMP reader) writes the information to the STA (tag), the STA's ack to acknowledge the reception of the PA's information is needed. This can be applied at least to the RFID use case.

Some implementations of an IEEE 802.11 bp frame, for example, by the AP/STA in the wireless communications system 100 depicted in FIG. 1, the wireless device 200 depicted in FIG. 2, and/or the wireless device 300 depicted in FIG. 3 are described.

In some embodiments, an IEEE 802.11 bp frame includes a frame header, an optional frame body, and a frame check sequence (FCS)(e.g., 16 bits).

In some embodiments, the frame header includes a frame control field, RA/TA ID, and an optional extended control field.

### In Some Embodiments, the Frame Control Field Includes

if the PHY header cannot indicate the tag type, a Tag Type field (e.g., 2 bits), which may indicate Backscatter Tag for RFID use case, Active Tag (active transmission) for active transmission use case, or WUR for WUR use case. If the PHY header can indicate the tag type, the Tag Type field does not exist.
a Frame Type field (e.g., 4 bits), which may indicate the type of Broadcast trigger, Unicast trigger, Response, or Ack,
a Protection Indication field (e.g., 1 bit); in some embodiments, the protection indication field does not exist in a frame of backscatter tag.
and a UL Data Rate field (e.g., 1 bit), which may be carried in a downlink (DL) frame to indicate the UL PPDU rate. In the UL frame, the field is reserved.

In some embodiments, both a RA ID and a TA ID are carried in a frame. In some embodiments, both a RA ID and a TA ID are carried in a unicast frame of backscatter tag or in a unicast frame of backscatter tag other than Ack. In some embodiments, one of a RA ID and a TA ID are carried in a frame. In some embodiments, the DL unicast frame of backscatter tag has no TA field and has a RA ID field carrying STA's ID. In some embodiments, the Ack frame of backscatter tag has no RA ID field and has a TA ID field carrying the STA's ID. In some embodiments, the UL unicast frame of backscatter tag other than Ack has no RA ID field and has a TA ID field carrying the STA's ID. In some embodiments, the RA/TA ID is not carried in a frame other than a Unicast trigger without delayed response and a Unicast Trigger with delayed response. In some embodiments, a 16-bit RA/TA ID is for backscatter use case. In some embodiments, a 12-bit RA/TA ID is for WUR use case.

In some embodiments, the Extended Control field includes a Frame length field if a frame body exists and a security field if a Protection field is equal to 1. In some embodiments, the Protection field and the security field do not exist in the frame of backscatter tag. In some embodiments, the Protection field is reserved in the frame of backscatter tag and the security field does not exist in the frame of backscatter tag.

In some embodiments, for backscatter tag (RFID use case), the frame body contains an RFID message from an AP (reader) to a STA (tag), for example, in backscatter use case, RFID Query, RFID Read, RFID Write, RFID Authentication.

In some embodiments, for backscatter use case, the frame body contains an RFID message from a STA (tag) to an AP (reader), for example, Cyclic Redundancy Check (CRC) result of EPC, EPC, information being read, RFID Authentication response.

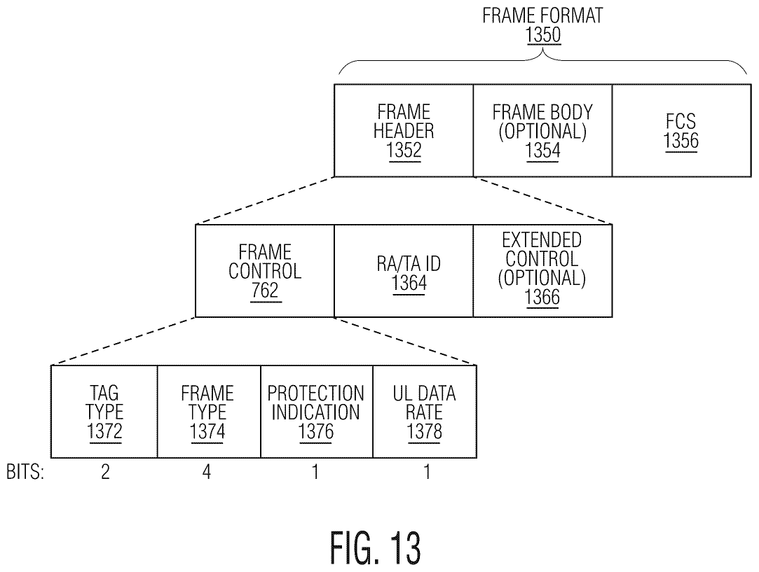

FIG. 13 illustrates an IEEE 802.11 bp compatible frame format 1350 in accordance with example embodiments. The frame format 1350 illustrated in FIG. 13 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 13, the frame format 1350 include a frame header (e.g., a MAC header) 1352, an optional frame body 1354, and an FCS 1356 (e.g., 16 bits). As illustrated in FIG. 13, the frame header 1352 includes a frame control field 1362 that may contain frame control information, a RA/TA ID 1364 that may contain either a RA ID and a TA ID or one of the RA ID and TA ID, and an optional extended control field 1366 that may contain extended control information. As illustrated in FIG. 13, the frame control field 1362 includes a Tag Type field 1372 (e.g., 2 bits) if the PHY header does not indicate the tag type which may be one of Backscatter Tag, Active Tag, and WUR, a Frame Type field 1374 (e.g., 4 bits), which indicates one of Broadcast trigger, Unicast trigger, Response, and Ack, a Protection Indication field 1376 (e.g., 1 bit) that may contain protection indication information, and a UL Data Rate field 1378 (e.g., 1 bit), which may be carried in a downlink (DL) frame to indicate the UL PPDU rate. In some embodiments, both a RA ID and a TA ID are carried in a frame. In some embodiments, only one of a RA ID and a TA ID is carried in a frame. In some embodiments, the RA/TA ID is not carried in a frame other than a Unicast trigger without delayed response and a Unicast Trigger with delayed response. In some embodiments, the unicast Trigger and Response share the same frame type. In some embodiments, a 16-bit RA/TA ID is for backscatter use case. In some embodiments, a 12-bit RA/TA ID is for WUR use case. In some embodiments, the Extended Control field 1366 includes a Frame length field and a security field. In some embodiments, for backscatter use case, the frame body 1354 contains an RFID message from an AP (reader) to a STA (tag), for example, in backscatter use case, RFID Query, RFID Read, RFID Write, RFID Authentication. In some embodiments, for backscatter use case, the frame body 1354 contains an RFID message from a STA (tag) to an AP (reader), for example, CRC result of EPC, EPC, information being read, RFID Authentication response. In some embodiments, for backscatter use case, Ack frame to the information being written to the tag does not include the frame body 1354. In some embodiments, the Protection field and the security field do not exist in the frame of backscatter tag. In some embodiments, the Protection field is reserved in the frame of backscatter tag and the security field does not exist in the frame of backscatter tag.

In some embodiments, in a variant to an IEEE 802.11 bp frame, a Session ID field is located after a Frame Control field, e.g., in an Extended Control field of a Frame Header.

In some embodiments, in another variant to an IEEE 802.11 bp frame, a Session ID field is located in a Frame Control field in a Frame Header.

In some embodiments, in another variant to an IEEE 802.11 bp frame, a Session ID field is located in the frame body.

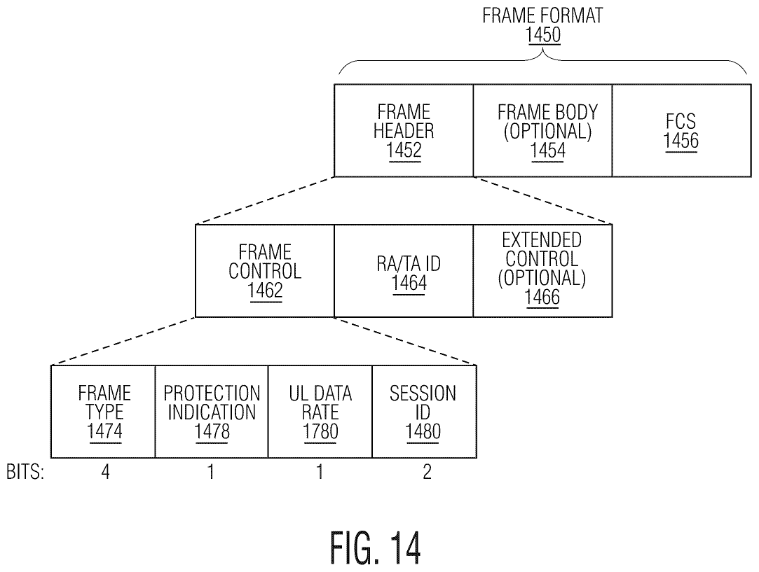

FIG. 14 illustrates an IEEE 802.11 bp compatible frame format 1450 in accordance with example embodiments when the PHY header indicates the tag type of the frame. The tag types of backscatter tag, active tag and WUR define the different frame header formats, e.g., different RA/TA ID length. The frame format 1450 illustrated in FIG. 14 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 14, the frame format 1450 include a frame header (e.g., a MAC header) 1452, an optional frame body 1454, and an FCS 1456 (e.g., 16 bits). As illustrated in FIG. 14, the frame header 1452 includes a frame control field 1462 that may contain frame control information, a RA/TA ID field 1464 that may contain either RA ID and TA ID or one of the RA ID and TA ID, and an optional extended control field 1466 that may contain extended control information. As illustrated in FIG. 14, the frame control field 1462 includes a Frame Type field 1474 (e.g., 4 bits), which may be Broadcast trigger, Unicast trigger, Response, or Ack, a Protection Indication field 1476 (e.g., 1 bit) that may contain protection indication information, a UL Data Rate field 1478 (e.g., 1 bit), which may be carried in a downlink (DL) frame to indicate the UL PPDU rate, and a session ID field 1480 (e.g., 2 bits).

In some embodiments, in a variant to an IEEE 802.11 bp frame, a Session ID field is located after a Frame Control field, e.g., in an Extended Control field of a Frame Header.

In some embodiments, in another variant to an IEEE 802.11 bp frame, a Session ID field is located in a Frame Control field in a Frame Header.

In some embodiments, in a third option, a session ID field is located in a frame body defined by an RFID protocol, e.g., in backscatter use cases.

Some implementations of a frame format, for example, by the STA/AP in the wireless communications system 100 depicted in FIG. 1, the wireless device 200 depicted in FIG. 2, and/or the wireless device 300 depicted in FIG. 3 are described.

In some embodiments, the frame body in a broadcast trigger frame includes the parameters for slot-based access with single random slot option (e.g., a threshold for access the slot is announced by the broadcast trigger frame, the number of slot announced by the broadcast Trigger frame is 1). In some embodiments, one broadcast Trigger frame announces one slot for the backscatter use case.

In some embodiments, the frame body in a broadcast trigger frame includes the parameters for slot-based access with multiple random slots option (e.g., the number of random slots announced by the Trigger and threshold for access one of the slots announced by the broadcast trigger frame).

In some embodiments, when the tag type announced by the PHY header is backscatter tag, the frame body in a unicast trigger frame (e.g., for backscatter use case) includes EPC Query command or its variant, Read command or its variant, Write command or its variant, Authentication command or its variant.

In some embodiments, when the tag type announced by the PHY header is backscatter tag, the frame body in a response (e.g., for backscatter use case) includes CRC code, EPC. In some embodiments, the frame body carries the information being read when the soliciting unicast Trigger carries Read command. In some embodiments, the frame body carries the authentication result when the soliciting unicast Trigger carries Authentication command.

In some embodiments, for a frame body in an Ack, no frame body exists when the response is the acknowledgement to the Write command.

In some embodiments, a broadcast trigger frame includes a frame header where the Extended Control field carries the parameters for slot-based access, a frame body, and an FCS. In some embodiments, the frame header includes a frame control field. In some embodiments, the frame Control field includes a Tag Type field, a Frame Type field indicating the Broadcast Trigger, a protection Indication field being reserved, and a UL Data Rate field. In some embodiments, the frame body includes Slot Number (the number of slots) and Probability Threshold (when a tag's random generated for a slot is more than the announced Probability Threshold, the tag transmits its ID in the slot).

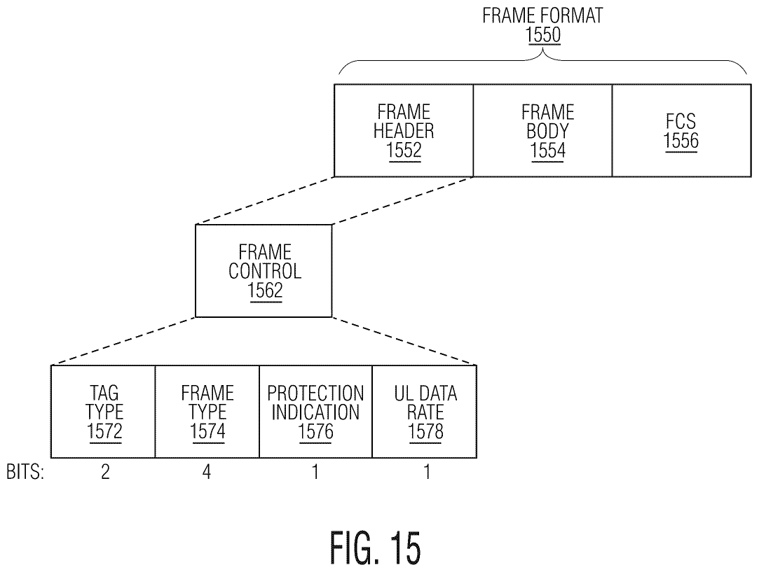

FIG. 15 illustrates a broadcast trigger frame format 1550 in accordance with example embodiments. The broadcast trigger frame format 1550 illustrated in FIG. 15 can be used for communications by the wireless communications system 100 depicted in FIG. 1, the wireless device 200 depicted in FIG. 2, and/or the wireless device 300 depicted in FIG. 3. In the embodiment depicted in FIG. 15, the broadcast trigger frame format 1550 include a frame header (e.g., a MAC header) 1552, an optional frame body 1554, and an FCS 1556 (e.g., 16 bits). As illustrated in FIG. 15, the frame header 1552 includes a frame control field 1562, which includes a Tag Type field 1572 (e.g., 2 bits), which may be Backscatter Tag, Active Tag, or WUR, a Frame Type field 1574 (e.g., 4 bits) indicating broadcast trigger frame, a Protection Indication field 1576 (e.g., 1 bit) that may contain protection indication information and is reserved, and a UL Data Rate field 1578 (e.g., 1 bit), which indicates the UL PPDU rate. In some embodiments, a TA ID field to carry the AP's ID follows the frame control field 1562. In some embodiments, the UL Data Rate field 1578 is reserved and the response will use a fixed data rate, e.g., the smallest data rate. In some embodiments, the UL Data field is reserved. In some embodiments, the Tag Type field 1572 does not exist if the PHY Header indicates the tag type. In some embodiments, the frame body 1554 includes random access parameters, e.g., Slot Number (the number of slots) and Probability Threshold (when a tag's random generated for a slot is more than the announced Probability Threshold, the tag transmits its ID in the slot). In some embodiments, the random access parameters are carried in Extended Control field.

In some embodiments, a unicast trigger frame includes a frame header, a frame body, and an FCS. In some embodiments, the frame header includes a frame control field, an RA ID, and an extended control field. In some embodiments, a TA field carries the transmitter's ID (AP's ID since the unicast Trigger frame is transmitted by an AP) and follows the RA ID for backscatter tag and the other tag types. In some embodiments, the frame Control field includes a Tag Type field, a Frame Type field indicating the unicast trigger, a protection indication field, and a UL Data Rate field. In some embodiments, the extended control field includes a length field and/or protection field. In some embodiments, the frame body includes one of Query, Read command, Select command, Write command. In some embodiments, the UL Data Rate field is reserved if the solicited frame is Ack. In some embodiments, the unicast Trigger and Response share the same frame type. In some embodiments, the Protection field and the security field do not exist in the frame of backscatter tag. In some embodiments, the Protection field is reserved in the frame of backscatter tag and the security field does not exist in the frame of backscatter tag.

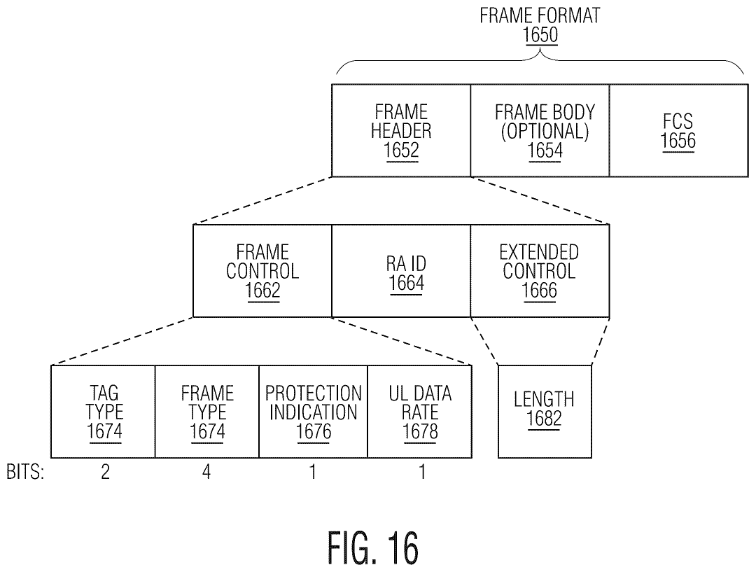

FIG. 16 illustrates a unicast trigger frame format 1650 in accordance with example embodiments. The unicast trigger frame format 1650 illustrated in FIG. 16 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 16, the unicast trigger frame format 1650 include a frame header (e.g., a MAC header) 1652, an optional frame body 1654, and an FCS 1656 (e.g., 16 bits). As illustrated in FIG. 16, the frame header 1652 includes a frame control field 1662, an RA ID 1664 that may contain RA ID information, and an extended control field 1666, which includes a length field 1682 that may contain length information and/or a security field that may contain the security information. In some embodiments, a TA field carries the transmitter's ID (AP's ID since the unicast Trigger frame is transmitted by an AP) and follows the RA ID field for backscatter tag and the other tag types. As illustrated in FIG. 16, the frame control field 1662 includes a Tag Type field 1672 (e.g., 2 bits), which may be Backscatter Tag, Active Tag, or WUR, a Frame Type field 1674 (e.g., 4 bits) indicating unicast trigger frame, a Protection Indication field 1676 (e.g., 1 bit) that may contain protection indication information, and a UL Data Rate field 1678 (e.g., 1 bit), which may be carried in a downlink (DL) frame to indicate the UL PPDU rate. In some embodiments, the UL Data Rate field 1678 is reserved and the response will use a fixed data rate, e.g., the smallest data rate. In some embodiments, the UL Data field is reserved when the unicast Trigger solicits an Ack. In some embodiments, the Tag Type field 1672 does not exist if the PHY Header indicates the tag type. In some embodiments, the frame body 1654 includes one of Query, Read command, Select command, Write command. In some embodiments, the unicast Trigger and the Response share the same frame type. In some embodiments, the Protection field and the security field do not exist in the frame of backscatter tag. In some embodiments, the Protection field is reserved in the frame of backscatter tag and the security field does not exist in the frame of backscatter tag.

In some embodiments, a response frame includes a frame header, a frame body, and an FCS. In some embodiments, the frame header includes a frame control field, an TA ID, and an extended control field. In some embodiments, a RA field carries the receiver's ID (AP's ID) and is right before the TA ID field for backscatter tag and the other tag types. In some embodiments, the frame Control field includes a Tag Type field, a Frame Type field indicating the frame type of response, a protection indication field, and a UL Data Rate field being reserved. In some embodiments, the extended control field includes a length field and/or the security field. In some embodiments, the Tag Type field 1672 does not exist if the PHY Header indicates the tag type. In some embodiments, the frame body includes one of an authentication response and a read response. In some embodiments, an Ack frame includes a frame header. In some embodiments, the unicast Trigger and the Response share the same frame type. In some embodiments, the Protection field and the security field do not exist in the frame of backscatter tag. In some embodiments, the Protection field is reserved in the frame of backscatter tag and the security field does not exist in the frame of backscatter tag.

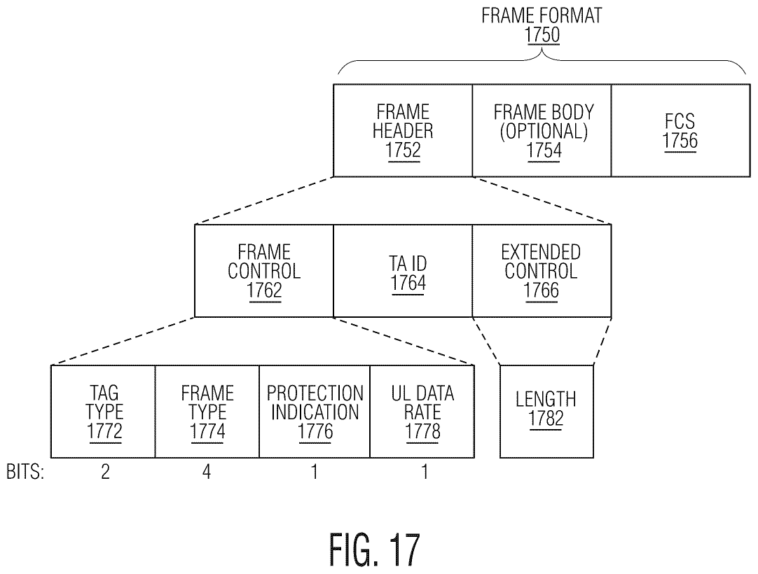

FIG. 17 illustrates a response frame format 1750 in accordance with example embodiments. The response frame format 1750 illustrated in FIG. 17 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 17, the response frame format 1750 include a frame header (e.g., a MAC header) 1752, an optional frame body 1754, and an FCS 1756 (e.g., 16 bits). As illustrated in FIG. 17, the frame header 1752 includes a frame control field 1762, an TA ID 1764 that may contain TA ID information, and an extended control field 1766, which includes a length field 1782 that may contain length information and the security field that may contain the security information. In some embodiments, a RA field carries the receiver's ID (AP's ID) and is right before the TA ID field for backscatter tag and the other tag types. As illustrated in FIG. 17, the frame control field 1762 includes a Tag Type field 1772 (e.g., 2 bits), which indicates one of Backscatter Tag, Active Tag, and WUR, a Frame Type field 1774 (e.g., 4 bits) indicating response trigger frame, a Protection Indication field 1776 (e.g., 1 bit) that may contain protection indication information, and a UL Data Rate field 1778 (e.g., 1 bit) being reserved. In some embodiments, the Tag Type field 1772 does not exist if the PHY Header indicates the tag type. In some embodiments, the frame body 1754 includes one of an authentication response and a read response. In some embodiments, the unicast Trigger and the Response share the same frame type. In some embodiments, the Protection field and the security field do not exist in the frame of backscatter tag. In some embodiments, the Protection field is reserved in the frame of backscatter tag and the security field does not exist in the frame of backscatter tag.

In some embodiments, an acknowledgement (Ack) frame includes a frame header and an FCS. In some embodiments, the frame header includes a frame control field. In some embodiments, the frame control field includes a Tag Type field if the PHY header does not contain the tag type information, a Frame Type field indicating the Ack frame, a protection Indication field being reserved, and a UL Data Rate field being reserved. In some embodiments, the Tag Type field does not exist in the frame control field if the PHY header contains the tag type information. In some embodiments, the TA ID is carried after the frame control field.

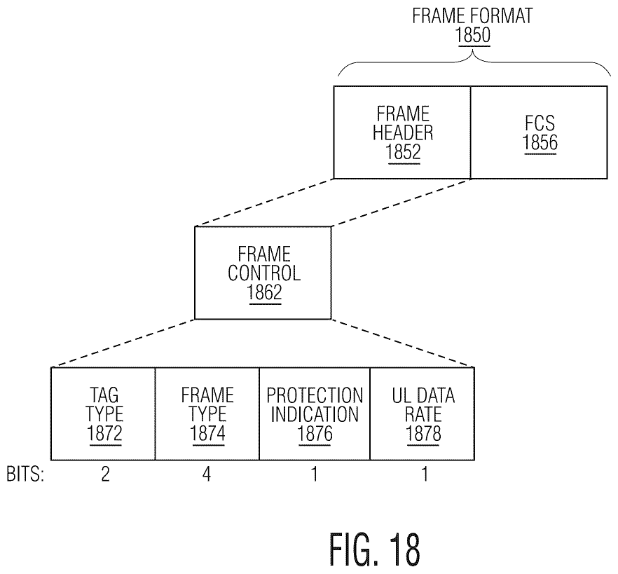

FIG. 18 illustrates an acknowledgement (Ack) frame format 1850 in accordance with example embodiments. The Ack frame format 1850 illustrated in FIG. 18 can be used for communications by the STA/AP in the wireless communications system 100 depicted in FIG. 1, the wireless device 200 depicted in FIG. 2, and/or the wireless device 300 depicted in FIG. 3. In the embodiment depicted in FIG. 18, the Ack frame format 1850 include a frame header (e.g., a MAC header) 1852 and an FCS 1856 (e.g., 16 bits). As illustrated in FIG. 18, the frame header 1852 includes a frame control field 1862, which includes a Tag Type field 1872 (e.g., 2 bits) if the PHY header does not caries the tag type information, which may be Backscatter Tag, Active Tag, or WUR, a Frame Type field 1874 (e.g., 4 bits) indicating Ack frame, a Protection Indication field 1876 (e.g., 1 bit) being reserved, and a UL Data Rate field 1878 (e.g., 1 bit) being reserved. In some embodiments, the Tag Type field does not exist in the frame control field 1862 if the PHY header contains the tag type information. In some embodiments, the TA ID is carried after the frame control field.

In some embodiments, a method of deliver information between an AMP first device and an AMP second device for various applications includes organizing, by the first device, the information with the different format for the different applications where the different applications are related to the different kinds of second devices, transmitting, by the first device, the information with the different formats in PSDU of AMP PPDU to the second devices of the related application, and decoding, by the second device, the information in PSDU of AMP PPDU with the specific format. In some embodiments, if the AMP PPDU carries the AMP SIG (11 bp SIG), the AMP SIG indicates the tag type of the frame carried in the PPDU. In some embodiments, the PHY header other that the AMP SIG (11 bp SIG) indicates the tag type of the frame carried in the PPDU, i.e., backscatter tag, active tag, WUR. In some embodiments, the frame control field in the frame header field of a frame of a tag type indicates the frame format of the frame indicated by the value in the frame type field. In some embodiments, the same value in the frame control field of the different tag types are the different frames with the different frame formats. In some embodiments, the frame (PSDU) carried in the AMP PPDU at least carries a Frame Header field, and an FCS field. In some embodiments, some frame carries a Frame Header, a frame body, and an FCS field where the frame body contains an RFID message in the frame of backscatter tag.

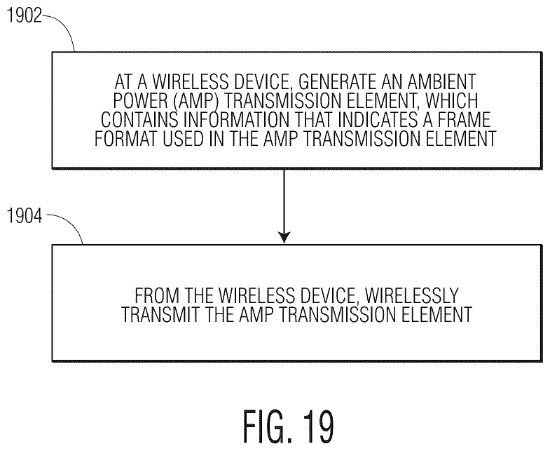

FIG. 19 is a process flow diagram of a method for wireless communications in accordance with example embodiments. At block 1902, at a wireless device, an AMbient Power (AMP) transmission element, which contains information that indicates a frame format used in the AMP transmission element, is generated. At block 1904, from the wireless device, the AMP transmission element is wirelessly transmitted. In some embodiments, the wireless device includes a wireless access point (AP), and the wireless AP includes an AMP tag reader. In some embodiments, the wireless device includes a non-access point (AP) station (STA), and the non-AP STA includes an AMP tag. In some embodiments, the AMP transmission element includes a Physical Layer Protocol Data Unit (PPDU), and the PPDU includes a Physical Layer Service Data Unit (PSDU) that carries a frame in the indicated frame format. In some embodiments, the PPDU carries a physical (PHY) header, and the PHY header contains the information that indicates a tag type of the frame carried in the PSDU. In some embodiments, the frame includes a frame header field, an optional frame body, and a frame check sequence (FCS). In some embodiments, the wireless device is compatible with an Institute of Electrical and Electronics Engineers (IEEE) 802.11 protocol. The wireless device may be the same as or similar to an embodiment of the STA 110-1, . . . , or 110-n and/or the AP 106 depicted in FIG. 1, the wireless device 200 depicted in FIG. 2, and/or the wireless device 300 depicted in FIG. 3.

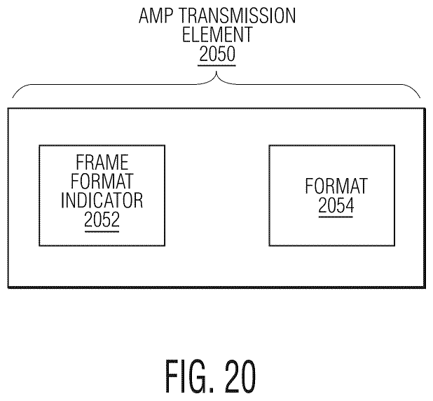

FIG. 20 illustrates an AMbient Power (AMP) transmission element 2050 in accordance with example embodiments. The AMP transmission element 2050 illustrated in FIG. 20 can be used for communications by the STA 110-1, . . . , or 110-n and/or the AP 106 depicted in FIG. 1, the wireless device 200 depicted in FIG. 2, and/or the wireless device 300 depicted in FIG. 3. In the embodiment depicted in FIG. 20, the AMP transmission element 2050 includes a frame format indicator 2052 that contains information that indicates a frame format used in the AMP transmission element 2050 and a frame 2054 in the indicated frame format by the information contained in the frame format indicator 2052. The frame 2054 depicted in FIG. 20 may have a format that similar to or the same as the IEEE 802.11 bp compatible frame format 1350 illustrated in FIG. 13, the IEEE 802.11 bp compatible frame format 1450 illustrated in FIG. 14, the broadcast trigger frame format 1550 illustrated in FIG. 15, the unicast trigger frame format 1650 illustrated in FIG. 16, the response frame format 1750 illustrated in FIG. 17 and/or the acknowledgement (Ack) frame format 1850 depicted in FIG. 18. In some embodiments, the frame format indicator 2052 is included or located in the frame 2054, for example, in a frame header of the frame 2054. In some embodiments, the AMP transmission element 2050 includes a Physical Layer Protocol Data Unit (PPDU), which includes a Physical Layer Service Data Unit (PSDU) that carries the frame 2054 in the indicated frame format. In some embodiments, the PPDU carries a physical (PHY) header, and the PHY header contains the information that indicates a tag type of the frame 2054 carried in the PSDU. In some embodiments, the frame 2054 includes a frame header field, an optional frame body, and a frame check sequence (FCS). In some embodiments, the frame header field contains a frame control field, a receiver address (RA) identification (ID) field and/or a transmitter address (TA) ID field, and an optional extended control field.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to generate an AMbient Power (AMP) transmission element, which contains information that indicates a frame format used in the AMP transmission element; and
a wireless transceiver configured to wirelessly transmit the AMP transmission element.

2. The wireless device of claim 1, wherein the wireless device comprises a wireless access point (AP), and wherein the wireless AP comprises an AMP tag reader.

3. The wireless device of claim 1, wherein the wireless device comprises a non-access point (AP) station (STA), and wherein the non-AP STA comprises an AMP tag.

4. The wireless device of claim 1, wherein the AMP transmission element comprises a Physical Layer Protocol Data Unit (PPDU), and wherein the PPDU comprises a Physical Layer Service Data Unit (PSDU) that carries a frame in the indicated frame format.

5. The wireless device of claim 4, wherein the PPDU carries a physical (PHY) header, and wherein the PHY header contains the information that indicates a tag type of the frame carried in the PSDU.

6. The wireless device of claim 5, wherein the frame comprises a frame header field, an optional frame body, and a frame check sequence (FCS).

7. The wireless device of claim 6, wherein the frame header field contains a frame control field, a receiver address (RA) identification (ID) field and/or a transmitter address (TA) ID field, and an optional extended control field.

8. The wireless device of claim 7, wherein the frame control field contains a frame type field and an uplink (UL) data rate field.

9. The wireless device of claim 8, wherein the UL data rate field is reserved in a frame transmitted by a station (STA).

10. The wireless device of claim 8, wherein the UL data rate field is reserved in a frame transmitted by an access point (AP) that solicits an acknowledgement (Ack).

11. The wireless device of claim 8, wherein the frame of a frame type carries a radio frequency identification (RFID) message.

12. The wireless device of claim 5, wherein frames of different tag types have different frame formats.

13. The wireless device of claim 8, wherein an access point (AP) does not transmit an acknowledgement (Ack) to a station (STA) after receiving a response from the STA.

14. An AMbient Power (AMP) reader comprising:
a controller configured to generate an AMP transmission element, which contains information that indicates a frame format used in the AMP transmission element; and
a wireless transceiver configured to wirelessly transmit the AMP transmission element to an AMP tag.

15. A method for wireless communications, the method comprising:
at a wireless device, generating an AMbient Power (AMP) transmission element, which contains information that indicates a frame format used in the AMP transmission element; and
from the wireless device, wirelessly transmitting the AMP transmission element.

16. The method of claim 15, wherein the wireless device comprises a wireless access point (AP), and wherein the wireless AP comprises an AMP tag reader.

17. The method of claim 15, wherein the wireless device comprises a non-access point (AP) station (STA), and wherein the non-AP STA comprises an AMP tag.

18. The method of claim 15, wherein the AMP transmission element comprises a Physical Layer Protocol Data Unit (PPDU), and wherein the PPDU comprises a Physical Layer Service Data Unit (PSDU) that carries a frame in the indicated frame format.

19. The method of claim 18, wherein the PPDU carries a physical (PHY) header, and wherein the PHY header contains the information that indicates a tag type of the frame carried in the PSDU.

20. The method of claim 19, wherein the frame comprises a frame header field, an optional frame body, and a frame check sequence (FCS).
